(19) United States
(12) Patent Application Publication
(10) Pub. No.: US 2017/0334139 A1
(43) Pub. Date: Nov. 23, 2017

(54) METHOD FOR ADDITIVE MANUFACTURING OF A 3D MECHATRONIC OBJECT

(71) Applicants: CENTRE NATIONAL DE LA RECHERCHE SCIENTIFIQUE, PARIS CEDEX 16 (FR); UNIVERSITE PARIS-SUD, ORSAY (FR)

(72) Inventor: Medhi AMMI, MASSY (FR)

(21) Appl. No.: 15/532,961

(22) PCT Filed: Dec. 10, 2015
(86) PCT No.: PCT/EP2015/079259

§ 371 Date: Jun. 2, 2017

(30) Foreign Application Priority Data
Dec. 11, 2014 (FR) 1462231

(51) Int. Cl. B29C 64/336; B33Y 50/02; B33Y 10/00; B29C 64/112; B29C 64/393; B33Y 80/00; B29L 31/34

(52) U.S. Cl. CPC B29C 64/336; B29C 64/393; B33Y 50/02; B33Y 80/00; B33Y 10/00; B29C 64/112; B29K 2995/0005; B29K 2995/0006; B29L 2031/3493

(57) ABSTRACT

A method for manufacturing a 3D mechatronic object having predetermined mechatronic functions, which includes as components at least one sensor and/or one actuator, an electronic circuit connected to the sensor and/or to the actuator via electrically conductive tracks, these components positioned in a main mechanical structure, and which consists of multiple polymers having various electronic and/or electroactive properties, comprises the following steps: determining the polymers according to their melting temperature, chemical compatibility, electrical and/or electroactive properties; determining a 3D digital model of the object, including its shape and the routing of the tracks, on the basis of predetermined mechatronic functions of the object, properties of the polymers and specifications of the object; 3D-printing the sensor and/or the actuator, the electronic circuit and the main structure in the same modeling steps according to the generated model by depositing layers of the molten polymers, certain layers being made up of a plurality of polymers, the layers being deposited by means of at least one head dedicated to a base polymer and coupled to a doping mechanism capable of injecting charged particles into the base polymer by interstitial doping so as to obtain the various polymers.

The field of the invention is that of manufacturing a 3D mechatronic object which includes as components:

a (force, pressure, flex, etc.) sensor and/or an actuator (vibrator, traverser, etc.);

an electronic circuit linked to the sensor and/or to the actuator and provided with electrically conductive tracks,

these components being positioned in a main mechanical structure.

The most commonly implemented solution for manufacturing a 3D mechatronic object consists in:

starting from a plurality of materials (dielectric materials, electrically conductive materials, etc.), manufacturing, on the one hand, the sensor and/or the actuator on a planar substrate;

manufacturing, on the other hand, the mechanical structure intended to accommodate the sensor and/or the actuator and producing the corresponding electronic circuit thereon;

assembling these two elements by transferring the sensor and/or the actuator into the structure and connecting it to the electronic circuit.

Today, additive manufacturing (or 3D printing) techniques allow complete 3D objects to be produced by adding material. Various methods currently exist for controlling the mechanical properties (e.g. material density, material type) or else the appearance of the printed objects (e.g. overall or local color, texture). However, these methods produce only passive objects without the capability to perceive or interact with their surroundings.

Inkjet 3D printing techniques exist for printing various electronic components like capacitors, field-effect transistors, photovoltaic cells, organic light-emitting diodes or even organic light-emitting diode (OLED) screens. In order to produce circuits requiring flexible substrates or substrates of large size, continuous or rotary 3D printing techniques are also being studied (flexography, rotogravure, roll-to-roll, etc.), for example in order to print flexible active-matrix organic light-emitting diode (AMOLED) screens.

The development of these various printing techniques has been made possible by virtue of the appearance of organic electronics. This branch of electronics makes use of conductive and semiconductive materials the composition of which is based on carbon chemistry: polymers. This branch of electronics is relatively new, as the first conductive polymers were developed in 1977 (Heeger, MacDiarmid, Shirakawa, Nobel Prize in Chemistry 2000) and the first electronic components using these materials appeared in the mid-80s: organic field-effect transistor (Mitsubishi, 1986); organic light-emitting diode (Kodak, 1987). Today, organic electronics make it possible to produce numerous electronic components, from electrochemical biosensors based on organic transistors (OFETs), such as pH or enzyme sensors, to actuators based on electroactive polymers (EAPs), such as artificial muscles or vibrotactile actuators. However, these efforts make use of basic manufacturing methods in which the elementary components (electrode, connector, etc.) are produced separately, then assembled to form the overall electronic component.

There are currently several studies looking into the use of additive manufacturing techniques to produce certain electronic components. However, these methods only produce components on planar substrates or which require additional assembly operations.

The aim of the invention is to overcome these drawbacks.

The method is primarily based on:
A particular choice of materials; these are polymer materials exhibiting various mechanical, electrical and electroactive properties.
Automatic generation of a model of the 3D object on the basis of the mechatronic functions of the object, properties of the polymers and technological or human factors.
3D printing using the model by depositing molten materials (FDM, which acronym stands for fused deposition modeling), which allows the chosen polymers to be deposited according to the generated model in order to manufacture the 3D object, i.e. the various components of the object (sensor, actuator, electronic circuit, packaging, etc.) in the same modeling steps.

More specifically, the subject of the invention is a method for manufacturing a 3D mechatronic object having predetermined mechatronic functions, which includes as components at least one sensor and/or one actuator, an electronic circuit connected to the sensor and/or to the actuator via electrically conductive tracks, these components being positioned in a main mechanical structure; the mechatronic object consists of multiple polymers having different electronic and/or electroactive properties. The method is primarily characterized in that it includes the following steps:

determining said polymers according to their melting temperature, their chemical compatibility, their electrical and/or electroactive properties;

determining a 3D digital model of the object, including its shape and the routing of the tracks, on the basis of predetermined mechatronic functions of the object, properties of said polymers and specifications of the object;

3D-printing the sensor and/or the actuator, the electronic circuit and the main structure in the same modeling steps according to the generated model by depositing layers of said molten polymers, certain layers being made up of a plurality of polymers, the layers being deposited by means of at least one head dedicated to a base polymer and coupled to a doping mechanism capable of injecting charged particles into the base polymer by interstitial doping so as to obtain the various polymers.

This method allows:

the production of complete mechatronic objects without having recourse to an assembly operation and hence without the drawbacks inherent to an assembly (leak-tightness, service life and control over seal expansion, etc.);

optimal integration of the components across various planes:
spatial: decrease in volume;
mechanical: actuator/sensor embedded within the structure, improved thermomechanical transmission/contact;
electrical: optimal electronic routing, electronic circuit with 3D structure;

the simple customization of mechatronic objects, in terms of structure and function;

a very short manufacturing time, from a few minutes to a few hours;

the use of inexpensive materials (polymers, which are optionally doped).

The molten polymer layers may be deposited by means of a plurality of deposition heads, each head being dedicated to a different polymer. At least one head is, for example, dedicated to a dielectric polymer and at least one other head is dedicated to a conductive polymer.

The invention also relates to a computer program comprising code instructions making it possible to perform the steps of the method when said program is run on a computer.

Other features and advantages of the invention will become apparent on reading the detailed description which follows, given by way of non-limiting example and with reference to the appended drawings in which:

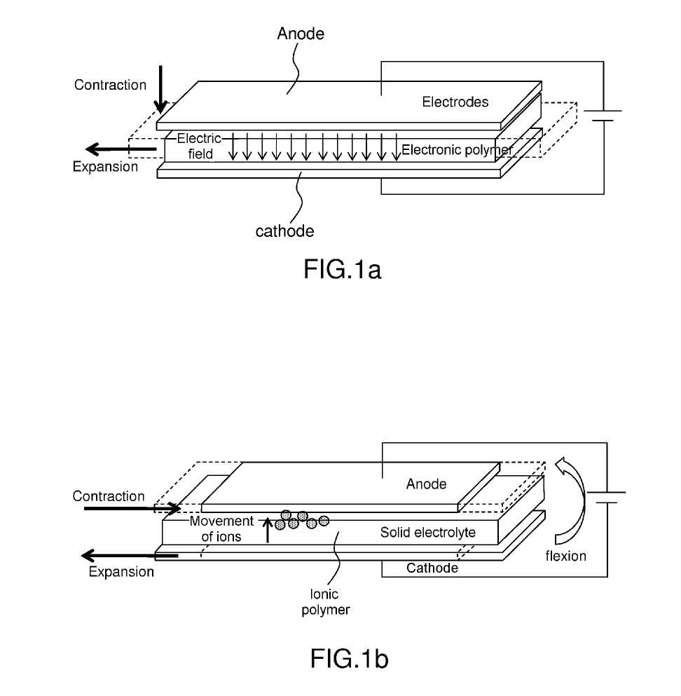

FIG. 1 schematically illustrate changes in dimensions caused by an electric field applied to an electronic polymer (FIG. 1a) and to an ionic polymer (FIG. 1b);

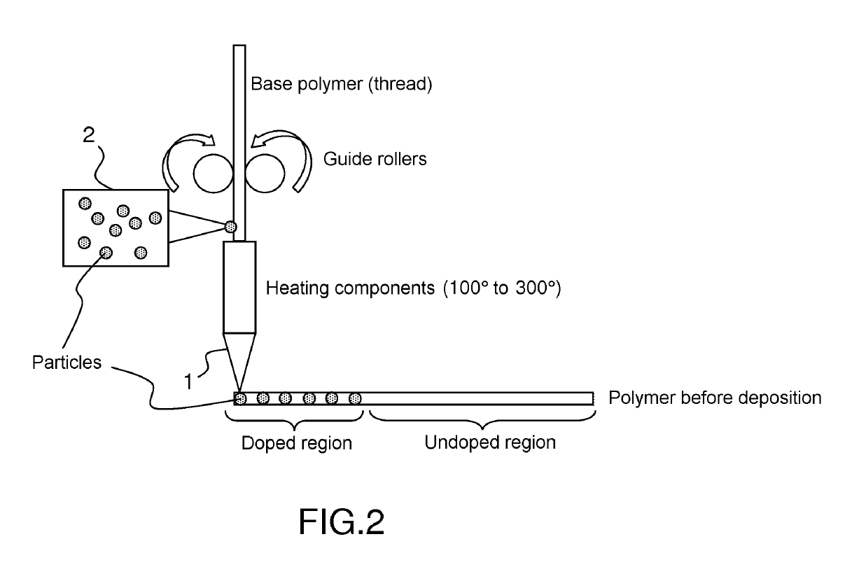

FIG. 2 schematically represents a deposition head coupled to a doping mechanism.

From one figure to another, the same elements bear the same references.

The 3D mechatronic object to be manufactured is defined by its mechatronic functions implemented by components, a sensor and/or actuator, an electronic circuit and a main mechanical structure which consist of multiple polymers having different electronic or electromechanical properties. The main mechanical structure may itself include articulations, which may potentially be controlled.

The method for manufacturing this object includes the following steps:

determining the polymers to be used to manufacture this object according to the properties of the polymers such as melting temperature, chemical compatibility or electrical or electromechanical properties;

determining a digital model of the 3D object, in particular its shape, the routing of the electrically conductive tracks and the structure and composition of the mechatronic components. In defining the model, the predetermined mechatronic functions of the object, the properties of the polymers and the predetermined specifications of the object are taken into consideration;

3D-printing the sensor and/or the actuator, the electronic circuit and the main structure in the same modeling steps by depositing layers of molten materials, certain layers being made up of a plurality of polymers.

The method is based on the use of polymers. These materials are advantageous since they are light, can be synthesized at low temperatures, are easy to use on an industrial scale, can be recycled, are inexpensive and are compatible with fused deposition modeling.

Polymers are primarily known for their dielectric properties. Studies have demonstrated the capabilities of certain polymers to conduct electricity. The past few decades have seen the appearance of polymers referred to as “smart materials”. These polymers exhibit various behaviors, for example mechanical or electroluminescent behaviors, under the effect of physical stimuli such as light, acidity, heat or a magnetic or electric field. In the case of a reaction to an electric field, electroactive polymers are spoken of. These polymers are capable of converting electrical energy to mechanical energy, for example through deformation (bending, compression, expansion, etc.). This property is suited to the production of various electromechanical transducers such as actuators or sensors.

These various properties (electrical insulation, electrical conductivity, electromechanical transduction) are used to produce the various passive and active components of mechatronic objects.

The three main families of polymers used in this method are:
dielectric polymers;
electrically conductive polymers;
electroactive polymers.

### I) Dielectric Polymer

This is a thermoplastic material which is used to construct the main mechanical structure of the object and which acts as an electrical insulator in the production of the various electronic components and structures. A wide range of thermoplastic materials exist which exhibit various physical properties. The choice of material depends on the properties with which it is desired to endow the object or certain portions or components of the object, such as:
Dielectric properties (component carrier, insulator/capacitor, component shell, etc.): dielectric strength, loss angle, electrostatics, etc.
Overall mechanical properties (skeleton) and local mechanical properties (input/contact areas, force/flex sensor, mechanical transmission, etc.): volumetric mass density, strength, flexibility, elasticity, resistance to pressure/bending/twisting, etc.
Thermal properties: heat capacity, thermal conductivity, etc.
Biological properties: chemical inertness/reactivity, toxicity, etc.
Visual properties: transparency/opacity, color, gloss/roughness, etc.
Ergonomic properties: contact comfort, surface roughness, texture, etc.

Another important point guides the choice of material: the melting point of the dielectric polymer and of the other polymers involved in the manufacture of the object (conductive polymers, electromechanical polymers, etc.). Specifically, it is necessary to use materials having similar melting points so as not to melt those portions that have already been printed which will make contact with the material being deposited.

The following table presents some dielectric polymers that are compatible with fused deposition 3D printing.

| | Melting | |
|---|---|---|
| Material | point | Properties |
| Acrylonitrile | 130° | Hard |
| butadiene styrene | | Shock resistant |
| (ABS) | | Light |
| | | Opaque |
| Polylactic acid (PLA) | 145° | Transparent |
| | | Compostable material |
| Polyester (PCL) | 60° | Nontoxic |
| | | Nonallergenic |
| | | Thermally insulating |
| | | Acoustically insulating |
| | | Hydrophobic |
| Polyepoxyde (Epoxy) | 50° | Biologically inert |
| Polyvinyl chloride | 180° | Different levels of mechanical |
| (PVC) | | strength |
| | | Opaque/transparent |
| | | Anti-slip/smooth |
| | | Matt/iridescent |
| | | Biologically inert |
| Polycarbonate (PC) | 140° | Excellent shock resistance |
| | | Dimensionally stable at ambient |
| | | humidity |
| | | Good heat resistance (−135° C. |
| | | and 135° C.) |
| | | Physiologically innocuous |
| | | Transparent |
| Polypropylene (PP) | 145° -> 175° | Hard/semirigid |
| | | Hydrophobic |
| | | Abrasion-resistant |
| | | Bend-resistant |
| | | Translucent/opaque |
| Polystyrene (PS) | 240° | Shock-resistant |
| | | Compression resistant |
| | | Impermeable/cleanable |
| | | Low density |
| | | Thermally insulating |
| Polyurethane (TPU) | 230° | Elastic (rubber-type elasticity) |
| | | Shear resistant |
| | | Abrasion resistant |
| | | Transparent |

### II) Electrically Conductive Polymer

Conductive material is involved in the production of various components of the mechatronic object:

Electrically conductive tracks and connectors of components

Electronic components: capacitor electrodes, resistor, inductor wire, etc.

Transducers
Mechanical transducers (sensor): contact, pressure, flex, etc. sensors
Thermal transducers (actuator): heating element
Thermal conductors: thermal stimulation, cooling, etc.

There are two main types of conductive polymers:

A) Intrinsically conductive polymers (ICPs), the conductivity of which must be increased by doping with electron donor or acceptor atoms (chemical doping, electrochemical doping, etc.). Currently, among doped intrinsically conductive polymers which exhibit good chemical stability and good mechanical properties, the following may be cited: polyparaphenylene, polythiophene, polypyrrole or polyaniline. However, these materials are not suitable for fused deposition modeling since melting temperatures partially or fully alter their electrical or mechanical properties.

B) Interstitially doped conductive polymers: this is a composite polymer consisting of a nonconductive polymer doped with conductive fillers in order to increase the conductivity of the composite polymer. The doping consists in adding charged particles to the nonconductive polymer in the liquid state. There is no chemical reaction between the two materials during or after doping. The mechanical properties of the composite polymer are close to those of the nonconductive polymer, and its electrical properties are close to those of the conductive fillers. It is necessary to use materials which are compatible with the temperatures of fused deposition modeling for the nonconductive polymer and the conductive fillers: it is necessary that the degradation temperature>>the melting point.

The resulting conductivity of the composite polymer depends on:
the conductivity of the conductive fillers;
the proportion of conductive fillers in the polymer matrix;
the shape of the conductive fillers;
the spatial distribution of the conductive fillers;
the polymer/conductive filler structural and electrical interaction.

On the basis of the shape and the distribution of the conductive fillers, it is possible to define the “packing factor” (F), which expresses the proportional volume of fillers in the composite.

$$F = \frac{{V}_{char}}{{V}_{char} + {V}_{com}}$$

$${V}_{char} \text{:} Volume occupied by the fillers$$

$${V}_{com} \text{:} Volume of the composite$$

This factor F defines multiple properties and parameters of the composite:
Conductivity (S/m)
Percolation threshold
Mechanical properties
Thermal properties.

The following table presents a few types of conductive fillers and some characteristics of the resulting composite polymer:

| Conductive | Nonconductive | Melting | | Other |
|---|---|---|---|---|
| fillers | polymer | point | Resistivity | properties |
| Metal | PS | 260° | 10−5 Ω-m | Very good |
| particles: | Polyimidesiloxane | (PS/nickel) | (PS/nickel) | electrical |
| nickel, copper, | (SIM-2030M) | 200-300° | 10−6 Ω-m | conductivity |
| silver, etc. | Epoxy | (SIM/nickel) | (SIM/nickel) | Good thermal |
| | PVC | | 10−6 Ω-m | conductivity |
| | | | (SIM/silver) | |
| Carbon black | PP | 60° (PCL) | 10−1 Ω-m | Low melting |
| | PMMA | -> | -> | point |
| | PEHD | 190° | 10 Ω-m | Lower amount |
| | ABS | (PEHD) | | of fillers |
| | PCL | | | Piezoresistive |
| | | | | Antistatic |
| Carbon | TPU | 400° (TPU) | 10−2 Ω-m | Good |
| nanotubes | PU | | -> | mechanical |
| | Polyaminoamide | | 10−6 Ω-m | strength |
| | | | | Good |
| | | | | elasticity (PU) |
| | | | | Good thermal |
| | | | | conductivity |
| Carbon fibers | HDPE | 130° | 10−4 Ω-m | Active textile |
| | EVA | (HDPE) | (FC + graphite) | |
| | | | 10−2 Ω-m | |
| | | | (FC) | |
| | | | -> | |
| | | | 10² Ω-m | |
| | | | (FC) | |
| Conductive | HDPE | 130° | 10−1 Ω-m | Piezoelectric |
| ceramic: PZT, | PMMA | (HDPE) | (HDPE) | |
| etc. | Epoxy | | | |

Other types of conductive fillers may also be used:
Metal fibers
Metalized mineral particles
Intrinsically conductive polymer particles.

In addition to controlling the electrical conductivity of the composite polymer, the material of the conductive fillers makes it possible to affect certain mechanical or thermal properties of the composite polymer and to make it sturdier (carbon fiber) or a better thermal conductor (metal fillers). It may also provide it with new functionalities (see below with electroactive polymers), for example piezoelectricity (ceramic) or piezoresistivity (carbon black).

### III) Electroactive Polymer

This material makes it possible to produce electroactive components which are required in particular for providing the object to be manufactured with mechanical perception and actuation capabilities. Two main classes of components may be produced:

1) sensors (contact, pressure, etc. sensors); and/or

2) actuators (vibrotactile actuator, flex actuator, linear actuator, etc.).

The method according to the invention uses electroactive polymers (EAPs) in particular as electromechanical transducers. These light and flexible polymers are capable of responding to electrical stimulation by changing size and shape (actuator mode). It is also possible to polarize them under the effect of mechanical strain (sensor mode).

There are two main categories of electroactive polymers: the electronic family and the ionic family.

A) Electronic polymers (electronic EAPs) are activated by an external electric field. In general, the electronic polymer is positioned between two electrodes, for example based on a conductive polymer, in order to apply an electric field thereto, for example in order to measure its polarization or its voltage. The electric field subjects the electronic polymer to forces resulting from electric polarization (intrinsic forces) and to the Coulomb force which is exerted on the electrodes (extrinsic forces). These forces result in changes in dimensions (transverse contraction=>longitudinal expansion), as illustrated in FIG. 1a.

The electronic polymer family consists of subfamilies which exhibit various intrinsic electrical properties and activation processes:
Ferroelectric polymer
Electrets
Dielectric elastomer
Electrostrictive graft elastomer
Electroactive paper
Electroviscoelastic elastomer
Liquid crystal elastomer (LCE)

B) Ionic polymers (ionic EAPs) are based on a diffusion of ions or molecules through the material, caused by an electric field. This diffusion of ions or molecules produces changes in the dimensions of the material (contraction/expansion of the electrodes=>flexing of the overall structure) as illustrated in FIG. 1b. Actuators making use of this type of polymer includes two electrodes between which a voltage is applied, for example based on a conductive polymer, separated by a solid (or liquid) polymer electrolyte.

The ionic polymer family also consists of subfamilies which make use of various physical or chemical principles:
Ionic gel
Ionic composite (IPMC)
Ion-conductive polymer (CP)
Carbon nanotubes
Electrorheological fluid.

These two main categories of electroactive polymers exhibit various electromechanical properties which determine their specifications:

the electromechanical coupling coefficient, which expresses the capacity to convert electrical energy to mechanical energy;

the activation electric field, which is the minimum electric field needed to produce a change in dimensions;

the maximum deformation, which expresses the maximum change in (longitudinal) dimensions;

the maximum pressure that the polymer is able to apply;

Young's modulus, which expresses the stiffness/elasticity of the material;

the energy density, which expresses the maximum mechanical energy per cycle and per unit volume of the material;

response time;

service life.

The following table summarizes the main advantages and drawbacks of each category.

| Category | Advantages | Drawbacks |
|---|---|---|
| Electronic | Large force generated | High activation electric field |
| polymers | Short response time | strength (20 to 150 MV/m) |
| | Long life | Single direction of |
| | Operation under ambient | deformation |
| | conditions | |
| Ionic | Substantial movements | Long response time |
| polymers | Low activation electric field | Small force generated |
| | strength (10 kV/m) | Operation under specific |
| | Direction of deformation | conditions |
| | linked to the polarity of the | Low electromechanical |
| | electric field | coupling |

The following table provides, for each category and some electroactive polymer subfamilies, an example of material that is compatible with fused deposition modeling.

| | | Activation | | | |
|---|---|---|---|---|---|
| | | electric field | Maximum | Coupling | |
| | Example of | strength | pressure | coefficient | |
| Subfamily | material | (V/m) | (MPa) | (%) | Notes |
| Ferroelectric | PVDF polymers | PVDF: 10⁵ | PVDF: 5 | PVDF: 33 | Increased |
| polymer | P(VDF-TrFE) | AFC: 10⁴ | AFC: 40 | AFC: 73 | manufacturing |
| | copolymer | MFC: 10³ | MFC: 31 | MFC: 72 | cost |
| | Macro fiber | | | | Low yield |
| | composites | | | | High useful |
| | (MFCs) | | | | strength |
| | Active fiber | | | | Very little |
| | composite | | | | deformation |
| | (AFC) | | | | Small size => |
| | | | | | high |
| | | | | | frequency |
| Electrostrictive | P(VDF-TrFE1- | 10⁷ | 20 | 25 to 55 | Low losses |
| graft | CTFE) | | | | High cost |
| elastomer | terpolymer | | | | High supply |
| | | | | | voltage |
| Dielectric | 3M VHB 4910 | Nusil | Nusil | Nusil | Substantial |
| elastomer | acrylic | silicone: 10⁸ | silicone: | silicone: | deformation |
| | Nusil CF19- | Deerfield | 0.72 | 54 | Low cost |
| | 2186 silicone | polyurethane: | Deerfield | Deerfield | Long life |
| | Deerfield | 10⁸ | polyurethane: | polyurethane: | |
| | PT6100S | Lauren | 3.8 | 21 | |
| | polyurethane | fluoroelastomer: | Lauren | Lauren | |
| | Lauren | 10⁸ | fluoroelastomer: | fluoroelastomer: | |
| | fluoroelastomer | | 0.39 | 15 | |
| | L143HC | | | | |
| | Aldrich PBD | | | | |
| | polybutadiene | | | | |
| Ion-conductive | PANI | 10 | 34 | 2 to 12 | PPy: melting |
| polymer (CP) | (polyaniline) | | | | point 300° C. |
| | PPy | | | | |
| | (polypyrrole) | | | | |
| IPMC | Nafion | Nafion: 10 to | Nafion: 10 to | Nafion: 3 | Complex to |
| | Flemion | 10² | 30 | | manufacture |
| | | | | | Very low |
| | | | | | supply voltage |

The choice of material to be used for producing the electrodes is also important. In order to strike the best compromise between electrical conductivity for optimum application of the electric field and elasticity required to accompany the changes in the dimensions of the electromechanical polymer, elastomer polymers doped with conductive fillers are used (see the section on conductive polymers).

For example, it is possible to produce a touch actuator (vibrator) using the AFC or MFC polymers positioned between two conductive electrodes made using the HDPE polymer.

Once the polymers which will be used in the manufacturing process have been chosen, the next step is the automatic generation of a model of the 3D object using software.

The model is generated on the basis of:
mechatronic functions of the object to be produced, which are predetermined;
the choice of polymers; and
base specifications input by the user by means of a user interface. It enters basic information of the type: bracelet, vibrotactile, wrist size, etc.

The software then proposes a main mechanical structure and sizes and positions the electronic circuit and other components.

The sizing of the components is linked to the mechanical, electrical and electroactive properties of the polymers used, human factors (psychophysical factors, perception thresholds, etc.) and functionalities specified by the user.

The simultaneous use of multiple electronic components in the fabrication of the object requires an optimum routing of the electronic tracks. Besides the electrical properties, the software also takes the mechanical and structural properties (flex points, stiffness, etc.) of the object into consideration.

The design software goes through the following processes:

positioning the actuators/sensors while taking ergonomic factors into account: the outer structure of the object (bracelet, object to be clasped, etc.), morphology of the user (size, shape, etc.), areas of stimulation, sensitivity (touch), relative and absolute perception threshold, etc.

sizing the actuators/sensors while taking psychophysical and electromechanical factors into account;

sizing and shaping the main mechanical structure while taking mechanical, electromechanical and ergonomic factors into account: thermal and mechanical transmission, intensity of the deformations/vibrations, structural integration, etc.

electronic routing while taking electrical and electronic factors into account: the conductivity of a track/electrode, inter-track effects, routing of the electronic tracks, etc.

For example, in order to add vibrotactile functionality to a bracelet, the software takes the minimum tactile perception threshold into account, as well as that relative with respect to the wrist. According to this threshold, it determines the intensity of the perception that the vibrating component must apply. The software next sizes the center polymer (positioned between the electrodes as shown in FIGS. 1a and 1b), which is for example an AFC or MFC, and the stimulation electrodes in order to generate the required pressure. The assembly is next automatically positioned on the inner surface of the bracelet in order to come into contact with the arm of the user.

In order to add a touch pressure sensor to a smart object, the software takes the location of the contact and the range of forces applied into account in order to generate a 2D pattern on the surface of the object using a piezoelectric conductive polymer (HDPE or PMMA). The deformation of the pattern causes a change in the resistivity of the conductor which allows the applied force to be measured.

The model of the 3D object thus obtained is sent to a specific printer which cuts it into slices and deposits the polymers layer by layer in order to obtain the final 3D object. According to the invention, certain layers consist of multiple polymers as may be seen in FIG. 2 (doped region, undoped region) and may be apertured (the surface is not completely covered).

The 3D printing uses fused deposition modeling (FDM). It is recalled that this modeling process consists in melting a polymer filament by feeding it through a deposition head (or nozzle or extruder) heated to a temperature of between 160 and 270° C. A small thread of melted polymer, the diameter of which is of the order of a 10th of a millimeter, is output therefrom. This thread is deposited in lines and is bonded by remelting to that which was deposited beforehand.

Two fused deposition strategies may be used to produce electromechanical objects.

The first deposition strategy consists in using a conventional fused deposition modeling 3D printer but with multiple deposition heads (also referred to as extrusion nozzles) instead of just one, each head being dedicated to the deposition of a different polymer. A minimum of two deposition heads is required for depositing a conductive material and an insulating material. This configuration makes it possible to produce the mechanical structure and the passive components (conductive track, resistive pressure/contact sensor, etc.). The addition of another deposition head makes it possible to deposit an electroactive polymer for the production of active transducers such as vibrotactile actuators or flex actuators. The operating temperature of each deposition head depends on the melting point of the deposited polymer. It is therefore necessary to choose a set of polymers (insulating, conductive and electroactive polymers) having similar melting points.

The second deposition strategy consists in using a base matrix (i.e. a dielectric base polymer) and to enrich it with charged particles upon deposition. Depending on the nature of the injected particles, the polymer acquires various conductive or electromechanical properties. This approach allows better control of the doping process and hence of the electrical (conductivity/electrical resistivity), mechanical (stiffness/elasticity), thermal (conductivity) and electromechanical (electromechanical coupling coefficient, etc.) properties of the deposited material. An advantage of this approach is that the same base polymer is used to produce the entire object which makes it possible to avoid the problem of chemical compatibility and different melting points between different polymers. Specifically, the mechanical properties of the base polymer remain dominant with respect to the properties of the dopant.

For this purpose, a fused deposition modeling 3D printer equipped with a deposition head is used. A single deposition head 1 is sufficient insofar as it is coupled to a doping mechanism 2 or a mechanism for enrichment with particles as shown in FIG. 2; this is interstitial doping in order to obtain various polymers for one and the same layer. This mechanism is a particle ejection head (using pressure for example) positioned before or after the heating mechanism of the main deposition head.

It is possible to use multiple doping heads coupled to respective doping mechanisms in order to inject various types of particles.

Among the mechatronic objects that can be fabricated in this way, the following may be cited: rigid or flexible mechanical structures (bracelet), circuit boards, sensors such as a strain gage, an electrodermal inductance sensor, a thermal probe, actuators such as a loudspeaker, a vibrator, a linear actuator or electronic components such as a resistor, a capacitor or an inductor.

This manufacturing method may in particular be implemented using hardware and/or software elements. It may be available as a computer program product comprising code instructions allowing the steps of the manufacturing method to be carried out. This program is recorded on a medium that can be read by computer. The medium may be electronic, magnetic, optical, electromagnetic or be a relay medium of infrared type. Examples of such media are semiconductor memories (random access memory RAM, read-only memory ROM), tapes, floppy disks or magnetic or optical disks (compact disk-read-only memory (CD-ROM), compact disk-read/write (CD-R/W) and DVD).

Although the invention has been described in conjunction with particular embodiments, it is clearly evident that it is in no way limited thereto and that it comprises all of the technical equivalents of the described means, as well as combinations thereof if the latter fall within the scope of the invention.

1. A method for manufacturing a 3D mechatronic object having predetermined mechatronic functions, which includes as components at least one sensor and/or one actuator, an electronic circuit connected to the sensor and/or to the actuator via electrically conductive tracks, these components being positioned in a main mechanical structure, and which consists of multiple polymers having different electronic and/or electroactive properties, comprising the following steps:
determining said polymers according to their melting temperature, their chemical compatibility, their electrical and/or electroactive properties;
determining a 3D digital model of the object, including its shape and the routing of the tracks, on the basis of predetermined mechatronic functions of the object, properties of said polymers and specifications of the object;
3D-printing the sensor and/or the actuator, the electronic circuit and the main structure in the same modeling steps according to the generated model by depositing layers of said molten polymers, certain layers being made up of a plurality of polymers, the layers being deposited by means of at least one head dedicated to a base polymer and coupled to a doping mechanism capable of injecting charged particles into the base polymer by interstitial doping so as to obtain the various polymers.

2. The method for manufacturing a 3D mechatronic object as claimed in claim 1, wherein the molten polymer layers are deposited by means of a plurality of deposition heads, each head being dedicated to a different polymer.

3. The method for manufacturing a 3D mechatronic object as claimed in claim 2, wherein at least one head is dedicated to a dielectric polymer and at least one other head is dedicated to a conductive polymer.

4. The method for manufacturing a 3D mechatronic object as claimed in claim 1, wherein the main mechanical structure includes articulations.

5. The method for manufacturing a 3D mechatronic object as claimed in claim 4, wherein the articulations are controlled.

6. A computer program product, said computer program comprising code instructions allowing the steps of the method as claimed in claim 1 to be carried out, when said program is executed on a computer.
